(19) United States
(12) Patent Application Publication
(10) Pub. No.: US 2004/0245343 A1
(43) Pub. Date: Dec. 9, 2004

(54) Printed, machine-readable code, document provided with a code of this type and a method for producing said code and document

(76) Inventor: Georg Depta, Freising (DE)

Correspondence Address: ROTHWELL, FIGG, ERNST & MANBECK, P.C., 1425 K STREET, N.W., SUITE 800, WASHINGTON, DC, 20005, US

(21) Appl. No.: 10/491,985

(22) PCT Filed: Oct. 4, 2002
(86) PCT No.: PCT/EP02/11141

(30) Foreign Application Priority Data
Oct. 8, 2001 (DE) 101494637

(51) Int. Cl. G06K 19/06

(52) U.S. Cl. 235/491

(57) ABSTRACT

Coding 1, in particular a bar code, is printed by intaglio printing on substrate 10, in particular a bank note. Individual coding areas 2, 3, 4 differ in their ink layer thickness. The printing ink contains luminescent and/or electroconductive and/or x-ray absorbing and/or infrared radiation absorbing substances, so that the different ink layer thicknesses can be differentiated by different signal intensities.

### CROSS-REFERENCE TO RELATED APPLICATION

This application is a §371 of PCT Application Serial No. PCT/EP02/11141, filed Oct. 4, 2002.

### FIELD OF THE INVENTION

This invention relates to a printed, machine-readable coding consisting of luminescent and/or electroconductive and/or x-ray absorbing and/or infrared absorbing printing ink, a document of value or security document having such a coding and methods for producing the coding and for producing the document.

### DESCRIPTION OF THE BACKGROUND ART

Printed codings are used as an authenticity feature and/or identification feature for example in connection with identity cards, passports, security labels for goods, bank notes, checks, vouchers and other documents of value or security documents.

DE-A 1 524 714 discloses such a coding. The coding described therein is produced by means of stamps by locally transferring luminescent material from a color carrier to an information carrier of paper in the manner of a mechanical typewriter. The coding can have coding areas that differ in their luminescent properties by being printed with different luminescent materials and thus luminescing in different spectral regions. Individual coding areas can also have a plurality of layers of different materials printed on each other so that the coding areas produce a different appearance depending on the excitation radiation used.

Production of the above-described coding is elaborate due to the use of a plurality of different printing inks, and the printing machines required are accordingly complex. The possibilities of varying the coding are limited by the number of available printing inks. Furthermore, exactly registered alignment of the individual coding areas requires an especially elaborate print mechanism. The repeat accuracy of the produced codings also depends on the quality of the print mechanism. The method is unsuitable for printing a high piece number of information carriers since it is comparatively slow.

### SUMMARY OF THE INVENTION

The problem of the present invention is to propose a coding that can be produced without great technical effort and with the greatest possible repeat accuracy even at high piece numbers, and in which individual coding areas are always exactly aligned with each other so that they are clearly distinguishable. In addition, the problem is to propose a document of value or security document having a corresponding coding and a method for producing the coding and a method for producing the document.

These problems are solved by the coding, document and two methods having the features of the independent claims. The subclaims designate advantageous embodiments and developments of the invention.

According to the invention, the coding is produced by intaglio printing. Apart from the fact that individual coding areas can differ in their length and width dimensions and their spacing from each other, it is provided according to the invention that individual coding areas differ in their ink layer thickness. Different ink layer thicknesses can be produced by steel gravure printing if the printing plate used is engraved at accordingly different depths.

It is in addition essential to the invention that the printing ink of the coding areas printed in different thickness contains machine detectable substances, so that the signal intensity increases or decreases with increasing ink layer thickness. This makes it possible to provide a coding feature that is evaluable by machine using one and the same machine detectable substance solely by varying the ink layer thickness.

According to the invention, the machine detectable substances are luminescent, electroconductive, infrared (IR) radiation absorbing or x-ray absorbing substances, since such materials are detectable contactlessly. Detection thus involves no wear of the coded document and no wear of the detector, the latter aspect being of special importance in particular for machine testing of bank notes, which are tested in extremely high piece numbers. Frequent testing of the documents would in addition lead to brush marks on the document in case of contact-type testing. This would make the measuring track visible and expose the position of the coding that is otherwise possibly invisible visually. Luminescent and electroconductive, partly also IR-absorbing, materials are also particularly suitable as coding materials because they can be admixed to the printing inks for example as particles without appreciably influencing the color effect of the printing inks. The color brilliance of the printing inks is instead retained when for example feature substances capable of luminescence have little or no inherent color, or largely colorless, electroconductive polymers are used. In addition many luminescent substances, electroconductive particles and IR or x-ray absorbing substances have the positive property that their ability to luminesce or electric conductivity or absorbability is retained unchanged for a long time and cannot be either changed or eliminated by external influences.

Electroconductive materials that can be used are preferably mica particles covered with an electroconductive coating. Suitable x-ray absorbing material is for example barium sulfate. IR absorbers to be used are organic absorbers, for example from the group of phthalocyanines, and inorganic absorbers, for example carbon in the form of carbon black or graphite.

Noncontacting measurement of an electroconductive coding is done either inductively or capacitively, whereby the measuring signal changes in proportion as the electric resistance of the coding changes with the ink layer thickness. Noncontacting measurement of a luminescent coding is usually done by means of excitation radiation directed toward the coding and a radiation detector sensitive to the luminescent radiation, whereby the measuring signal changes in proportion as the radiation intensity of the coding changes with the ink layer thickness. The same applies to an x-ray absorbing coding, whereby x-rays are used instead of the excitation radiation. The thicker the ink layer with the absorbing substances is, the more the intensity of the x-radiation is weakened. With IR absorbers, the infrared radiation is accordingly weakened.

Compared with the above-described coding with coding areas consisting of different printing inks, the invention offers the advantage that only one machine-readable substance is required for producing the coding. This makes both production and testing of the coding simpler, since only one defined parameter must always be tested, namely the electric resistance in the case of an electroconductive coding, and the radiation intensity of a single wavelength in the case of a luminescent or absorbing coding. This does not rule out that printing inks with different luminescent properties are used within a coding, so that for example different areas of the coding respond and might become visible depending on the wavelength of the excitation radiation.

Luminescent printing inks that can be used are accordingly photoluminescent inks, in particular ones with fluorescent substances, which thus luminesce practically only during their excitation, and ones with phosphorescent substances, which continue to glow for a certain time after excitation has stopped.

Variation of ink layer thickness by intaglio printing is done via the depth of the engraving of the printing plates used for intaglio printing. The complete code can thus be engraved into a single plate, so that the individual coding areas assume exactly the same position relative to each other for all codings printed with the plate. The codings are thus not only producible in a single printing pass and exactly repeatable, but can also be produced in high piece numbers without great technical effort. Since different coding areas cannot overlap, all coding areas are reliably differentiable from each other. Apart from variation of ink layer thickness, the individual coding areas can differ in their dimensions and their spacing. In this way a virtually unlimited number of different codings can be created.

Preferably, the ink layer thicknesses of adjacent coding areas do not run into one another but traverse a minimum in the area of the boundary line between the coding areas. This permits coding areas to be clearly separated from each other. The thin separation bar between adjoining coding areas is so narrow that it is visually imperceptible. This has the consequence that adjacent coding areas cannot be distinguished visually when both areas are printed with the same, covering printing ink but the areas can be exactly distinguished for example due to different luminescent intensities.

WO 00/20216 describes how directly adjacent ink areas with different layer thickness that do not run into one another and are clearly delimited can be produced by intaglio printing. Accordingly, for producing adjacent ink areas the engraved areas associated with the ink areas on the printing plate are separated by a separation edge, the separation edge tapering at the level of the printing plate surface. Adjacent ink areas of documents thus printed traverse a minimum of ink layer thickness in the boundary area. The boundary line is so fine that it is only recognizable with a magnifying lens. The printing plates necessary for producing such adjacent ink areas are engraved with a rotating graver, which preferably has a flank angle corresponding to the flank angle to be produced on the separation edge. The engraved areas are thus milled into the engraved plate. Such precise engraving structures cannot be produced by conventional etching methods.

In addition it is possible to produce large-surface coding areas by intaglio printing by dividing the particular associated area of the engraved plate into partial areas that are separated by separation bars located in the engravings. The separation bars can either taper at the level of the printing plate surface or form a pattern on the base of the engraved area, whereby they serve as an “ink trap” for the printing ink. In any case, the ink layer printed on the document has a fine surface structure that is hardly recognizable visually without a magnifying lens. The viewer thus has the impression of a uniform, large-surface color print. The production of such engraved plates and documents printed therewith are described in WO 00/20217. It is not possible to produce intaglio printing plates for large ink areas with a uniform color effect using other engraving techniques.

However, it is not compulsory that the individual areas of the coding are directly adjacent or contiguous. In particular in cases where an object provided with the coding is moved fast during testing, for example in the machine testing of bank notes, it can be expedient to dispose the individual coding areas at a clear distance apart. In extreme cases, individual coding areas can even be disposed on opposite edges of an object or document.

The use of printing inks containing fluorescent or electroconductive or x-ray or infrared radiation absorbing substances that do not influence the color effect of the printing ink has the advantage that the coding can be integrated inconspicuously into a printed image by printing individual areas or the total printed image with the machine-readable printing ink. In particular, it is possible to integrate a coding into a homogeneous looking, large color area, for example as a bar code visually indistinguishable from its surroundings. It is also possible to produce a two-dimensional bar code, thereby potentiating the number of different coding variants.

When the individual coding areas are to be visually indistinguishable, it is advantageous to print the coding areas with a same-color, opaque, covering printing ink, whereby the ink layer thicknesses must be selected to be at least thick enough to convey a uniform color effect.

The substrate material on which the coding is printed may be any material that can be printed by intaglio printing. So-called security paper is preferably used. Security paper not only has a surface roughness that improves ink transfer from the printing plate to the substrate surface, but also has further authenticity features that are difficult to forge, for example watermarks and security threads.

### BRIEF DESCRIPTION OF THE DRAWINGS

In the following the invention will be explained by way of example with reference to the accompanying drawings, in which:

FIG. 1 shows an inventive coding in the form of a bar code;

FIG. 2 shows an inventive coding as a two-dimensional bar code;

FIG. 3 shows a detail of a cross section through a document with a bar code according to FIG. 2;

FIG. 4a shows a document with an all-over bar code;

FIG. 4b shows a detail of a cross section through the document of FIG. 4a;

FIG. 5a shows a document with an all-over bar code;

FIG. 5b shows a detail of a cross section through the document of FIG. 5a;

FIG. 6 shows a bar code with filigree signal lines;

FIG. 7a shows a coding integrated into a printed image;

FIG. 7b shows a detail of a cross section through a substrate with a printed image according to FIG. 7a.

### DETAILED DESCRIPTION OF THE INVENTION

FIG. 1 shows a coding according to a first embodiment of the present invention in the form of a bar code consisting of a sequence of differently spaced bars of variable width. The bar code is printed by intaglio printing with a luminescent printing ink common to all bars. Individual bars can, if needed, also be printed with differing printing inks, in particular without luminescent properties. Bars 2 differ from bars 3 in their ink layer thickness. Using a suitable sensor that excites the luminescent substances contained in the ink layers by means of suitable excitation radiation and receives the luminescent radiation by means of a suitable radiation detector, bar code 1 can be detected in every dimension and decoded. The layer thickness of individual bars 2, 3 is the “third dimension” here, so to speak, and is proportional to the detected radiation intensity. A potential forger would not readily expect this third dimension and therefore not readily discover it.

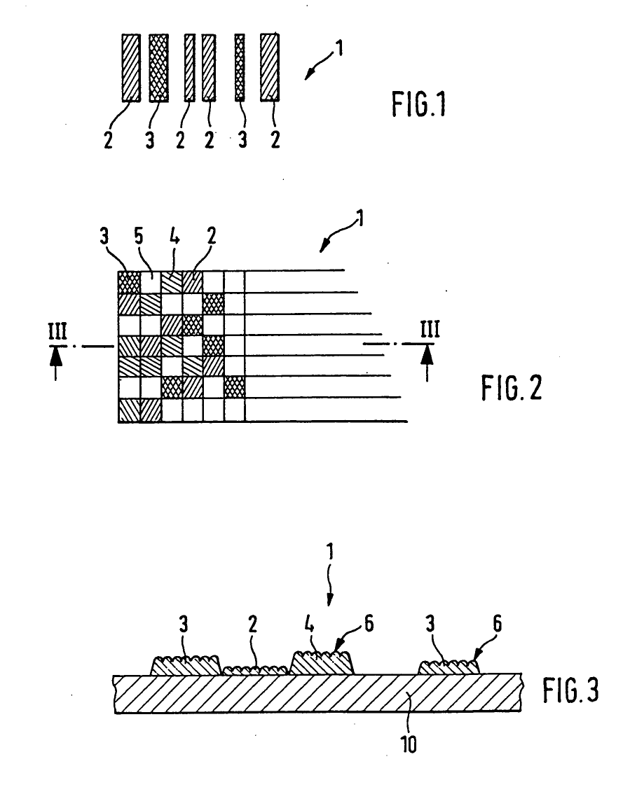

FIG. 2 shows a further embodiment of an inventive coding as a two-dimensional bar code. The individual coding areas are of square form, but can have any desired form and need not necessarily be located in a regular screen. The two-dimensional bar code has free areas 5 and printed areas 2, 3, 4, whereby printed areas 2, 3, 4 are again printed in a single printing pass by intaglio printing with the same printing ink and differ in their ink layer thickness.

FIG. 3 shows coding 1 from FIG. 2 on document 10 in cross section along line III-III. It can be seen that coding areas 2, 3, 4 differ in their ink layer thickness. The coding areas are in addition clearly delimited from each other since the ink layer thickness of adjacent coding areas traverses a minimum in the particular boundary line. Furthermore, the surfaces of the ink layers of the particular coding areas have fine structure 6, which comes from the fact that the base surface of the associated engraved area of the printing plate with which the coding is printed has a corresponding fine structure in the form of separation bars. As explained at the outset, the separation bar technique permits production of adjacent coding areas that look homogeneous in color and have large dimensions of distinctly over 1 square millimeter in surface and an edge length of over 0.5 millimeters in the way shown in FIG. 3.

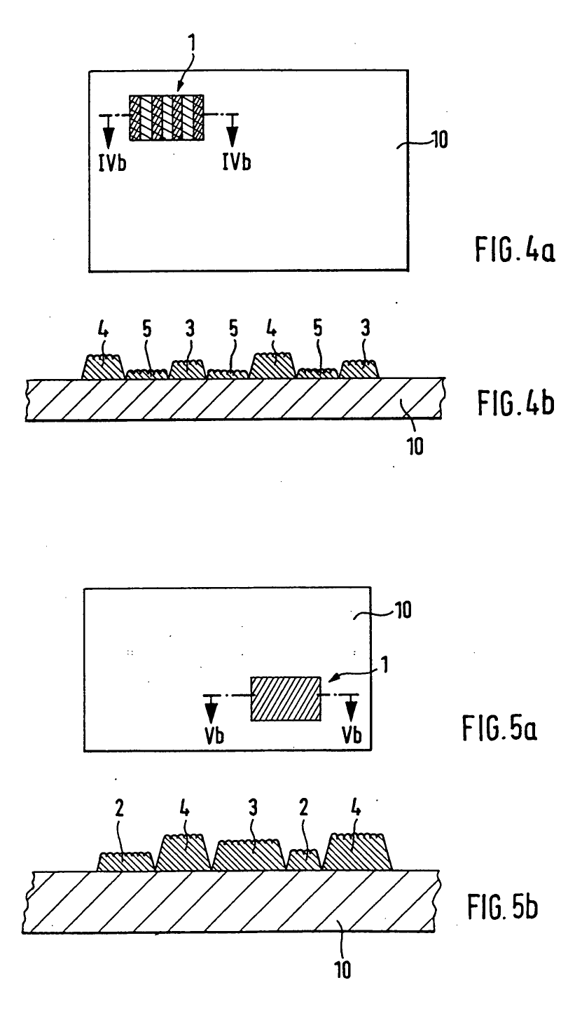

FIG. 4a shows document 10 with coding 1 in the form of a bar code printed with luminescent ink. The bar code is formed all over, that is, the areas between the bars are likewise printed with an ink layer consisting of the same luminescent ink but it can be visually distinguished well from the bars due to its low opacity and small layer thickness. FIG. 4b shows the document from FIG. 4a in a detail of the cross section, and the different layer thicknesses are apparent. Thin printed intermediate areas 5 between bars 3, 4 all have the same layer thickness and are therefore rated in the machine evaluation of the measuring signal as distances between actual bars 3, 4 forming the bar code. The layer thicknesses of bars 3, 4 forming the coding are selected to be great enough to have maximum color saturation and therefore produce the same color effect optically and thus not be readily distinguishable to a potential forger. Bars 3, 4 are uniformly spaced in this case, so that a potential forger will first assume he is faced with a regular light/dark screen. The information to be kept secret is instead coded by variation of the layer thicknesses of individual bars 3, 4. Bars 3, 4 can only be differentiated by their different luminescent radiation intensity using a suitable sensor.

FIG. 5a shows a further embodiment of the invention. Coding 1 is again a bar code, as indicated by the detail of the cross section according to FIG. 5b. In a plan view (FIG. 5a), however, the individual bars are not to be distinguished from each other on document 10 since the selected printing ink is opaque and present in all coding areas 2, 3, 4 with such a minimum layer thickness that its visual color effect is identical. The viewer thus sees a homogeneous color area although he is faced with a bar code, whose bars differ here not only in their ink layer thicknesses but also in their width dimensions. Accordingly, the measuring signal varies both with respect to the intensity level and with respect to the signal duration per intensity level when the coding is guided past a sensor at uniform speed during measurement.

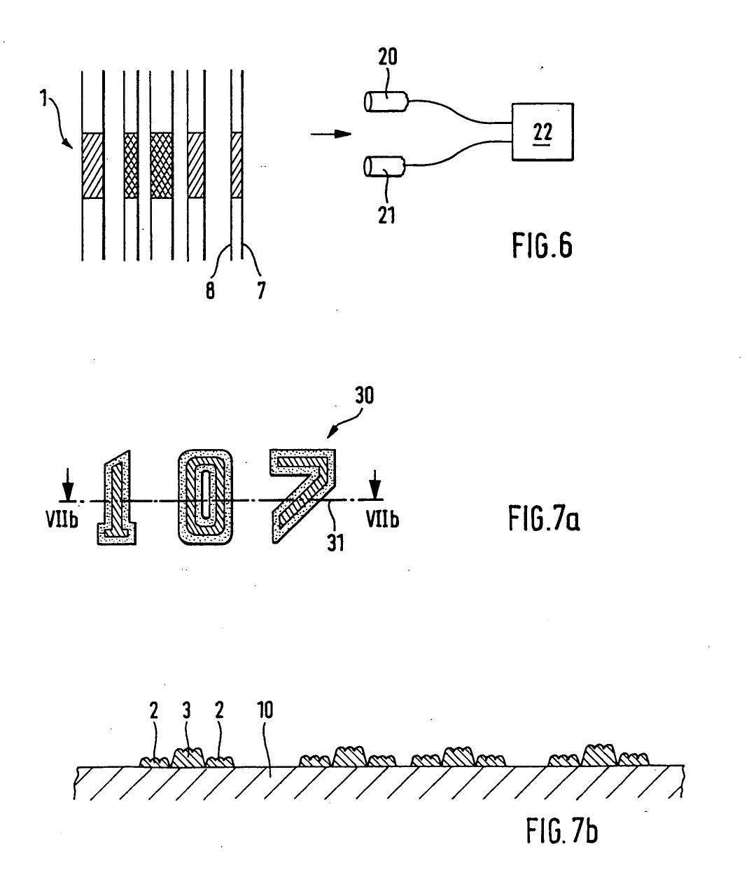

FIG. 6 shows a further form of the embodiment of the invention already described with respect to FIG. 1, according to which coding 1 is printed as a bar code with bars of different ink layer thickness. Accordingly, the beginning of a bar and the end of a bar are marked with filigree signal lines 7, 8, respectively, which are produced in a printing operation with the same engraved plate as the bar code itself. The fact that the engraved areas are produced with the same printing plate for coding 1 and for signal lines 7, 8 ensures that coding 1 and signal lines 7, 8 are exactly aligned with each other. A document provided with such a print can therefore be checked visually as to whether the alignment of signal lines 7, 8 is in exact register with the bars of coding 1.

Signal lines 7, 8 also have a second function. Signal lines 7, 8 are also printed with a printing ink containing feature substances and therefore machine-readable, and can be detected by sensor 20 which thus detects the beginning and end of each bar of the bar code when the coding is moved past under sensor 20 in the direction of the arrow. The bar code itself is detected by second sensor 21, and in evaluation device 22 connected with sensors 20, 21 it is checked whether the clocking detected by sensor 20 correlates with the sequence of bar code bars detected by sensor 21.

FIG. 7a shows a further embodiment of the invention in which the coding is integrated in printed image 30. In the shown embodiment, printed image 30 is a digit string whereby each digit has a frame surrounding the digit. As explained in connection with the previous embodiments, a suitable color choice and ink layer thickness adjustment make the frame and the digit surrounded by the frame visually indistinguishable. However, since the layer thicknesses of the digits and/or the frames surrounding the digits are different, the printed image has a coding readable only by machine.

If for example a substrate provided with printed image 30 is viewed along measuring track 31 in cross section, as shown in FIG. 7b, there is a characteristic arrangement of printed areas 2, 3 with different ink layer thicknesses. The coding is formed by this layer thickness sequence and can be detected by means of a suitable sensor and evaluated, if a for example luminescent or electroconductive printing ink is used.

Besides the explicitly stated feature substance, each of the inventive codings shown in the figures can also be executed with one of the feature substances from the group: luminescent, electroconductive, x-radiation absorbing and infrared absorbing.

Although a special advantage of the invention is that a single printing ink with luminescent and/or electroconductive and/or x-ray absorbing and/or IR radiation absorbing properties is necessary for producing the coding, the use of different printing inks can also offer advantages. By stencil inking one can for example print areas in the surroundings of the actual coding with an in particular visually identical printing ink but without feature substances. This disguises the position of the coding on the document, on the one hand, and makes such a coding more difficult to forge, on the other hand, since in an attempt to copy coding and surroundings by two separate printing operations the print of the coding with the ink containing the feature substance would have to be in exact register with the print of the surroundings with normal ink. However, the required exactness is not attainable with two successive printing operations.

1. A coding (1) produced by intaglio printing and comprising at least one of luminescent, electroconductive, x-ray absorbing, and infrared radiation absorbing printing ink, wherein the coding is comprised of coding areas (2, 3, 4) with different ink layer thickness.

2. A coding according to claim 1, wherein the printing ink is fluorescent.

3. A coding according to claim 1, wherein the printing ink is phosphorescent.

4. A coding according to claim 1, wherein the coding areas (2, 3, 4) are integrated into a printed image (30).

5. A coding according to claim 1, wherein the coding (1) forms a bar code.

6. A coding according to claim 5, wherein the bar code is a two-dimensional bar code.

7. A coding according to claim 1, wherein the printing ink of at least individual coding areas (2, 3, 4) differing in ink layer thickness is the same color, opaque and covering, and present in an ink layer thickness such that said individual coding areas are visually undifferentiable.

8. A coding according to claim 1, wherein the ink layer thickness traverses a minimum in the area of the boundary line between adjacent coding areas (2, 3, 4).

9. A coding according to claim 1, wherein at least individual coding areas (2, 3, 4) have a surface relief with a fine structure (6).

10. A coding according to claim 1, wherein all coding areas (2, 3, 4) are produced with the same printing ink.

11. A coding according to claim 1, wherein at least individual coding areas are surrounded by printing ink that is visually indistinguishable from the printing ink of the coding but is not luminescent or electroconductive or infrared radiation absorbing or x-radiation absorbing.

12. A document of value or security document comprising a coding according to claim 1.

13. A document of value or security document according to claim 12, wherein the document is an identity card, passport, security label for goods, bank note, check, voucher or admission ticket.

14. A method for producing a coding (1) according to claim 1, comprising the steps of:
providing a substrate (10),
producing the coding (1) on the substrate (10) by applying at least one of a luminescent electroconductive x-radiation absorbing and infrared radiation absorbing printing ink by intaglio printing in such a way that the coding (1) comprises coding areas (2, 3, 4) with different ink layer thickness.

15. A method according to claim 14, wherein a luminescent printing ink is used.

16. A method according to claim 14, wherein a phosphorescent printing ink is used.

17. A method according to claim 14, wherein the coding (1) forms an integral part of a printed image (30).

18. A method according to claim 14, wherein the coding is produced in the form of a bar code.

19. A method according to claim 18, wherein the bar code is a two-dimensional bar code.

20. A method according to claim 14, wherein the printing ink is selected to be the same color, opaque and covering for at least individual coding areas (2, 3, 4) differing in ink layer thickness, and is applied in an ink layer thickness such that the individual coding areas (2, 3, 4) are visually undifferentiable.

21. A method according to claim 14, wherein the ink layer thickness is formed so as to traverse a minimum in the area of the boundary line between adjacent coding areas (2, 3, 4).

22. A method according to claim 14, wherein the ink layer thickness is produced at least in individual coding areas in such a way that the ink layer has a surface relief with a fine structure (6).

23. A method according to claim 14, wherein all coding areas (2, 3, 4) are produced with the same printing ink.

24. A method according to claim 14, wherein at least adjacent to individual coding areas, printing ink is printed that is visually indistinguishable from the printing ink of the adjacent coding area but is not luminescent or electroconductive or x-ray absorbing or infrared absorbing.

25. A method according to claim 14 for producing a document of value or security document according to any of claims 12 or 13 comprising a coding (1) produced by intaglio printing and comprising at least one of luminescent, electroconductive, x-ray absorbing, and infrared radiation absorbing printing ink, wherein the coding is comprised of coding areas (2, 3, 4) with different ink layer thickness, wherein the substrate (10) is formed by the document of value or security document itself or by an intermediate product for producing the document of value or security document.

26. A method according to claim 14, characterized in that the coding is produced in a single printing pass.
